(19) United States
(12) Patent Application Publication
(10) Pub. No.: US 2004/0252379 A1
(43) Pub. Date: Dec. 16, 2004

(54) Microscope having at least one beam splitter and a scattered light reducing device

(75) Inventor: Albrecht Weiss, Linden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/866,139

(22) Filed: Jun. 11, 2004

(30) Foreign Application Priority Data
Jun. 13, 2003 (DE) 103 27 113.9

(51) Int. Cl. G02B 27/14

(52) U.S. Cl. 359/629

(57) ABSTRACT

A microscope having at least one beam splitter in the microscope beam path and a scattered light reducing device comprises as the scattered light reducing device a black glass plate that has a polished surface on which an antireflection coating is applied. The black glass plate is preferably arranged behind the beam splitter at a slight inclination with respect to the direction of the incoming illumination beam, so that a residual reflection occurring at the black glass plate is reflected out of the microscope beam path by the beam splitter.

This application claims priority to German patent application 103 27 113.9, the subject matter of which is hereby incorporated by reference herein.

The invention concerns a microscope having at least one beam splitter and a scattered light reducing means.

### BACKGROUND

In microscopes having an incident-light illumination beam path and an imaging beam path, the incident-light illumination is coupled in via a beam splitter mirror. In fluorescence microscopes, this is usually a dichroic beam splitter. With other incident-light methods in microscopy, for example the bright-field method, the polarization method, or differential interference contrast (DIC), the beam splitter is a neutral splitter having a reflectivity or transmissivity of approximately 50 percent. Whereas in the case of the neutral splitter approximately 50% of the incoming light passes through the beam splitter, with the dichroic beam splitter only a very small portion of the exciting light is allowed to pass through the beam splitter.

The light that passes through the beam splitter then strikes the wall arranged behind the beam splitter; can be partially absorbed, reflected, or scattered there depending on the wall material; and can ultimately enter the microscope's eyepiece or camera port as a disruptive background. This considerably impairs the image quality.

DE 19 926 037 A1 discloses a microscope having at least one beam splitter, in a beam splitter cube, which is provided in particular for the examination of fluorescing samples. The back wall behind the beam splitter is removed, and the beam splitter cube is thus open. Arranged outside the beam splitter cube is a reflective hollow cone which the light passing through the beam splitter strikes so that it is reflected out of the beam path. A revolving turret is described having several beam splitter cubes arranged thereon, in the middle of which a reflective hollow cone is arranged. As a result, the turret must be designed to be correspondingly large. Since the beam splitter cube is open, dust can penetrate into the beam splitter cube and settle on the back side of the beam splitter. There it is directly illuminated and generates an additional scattered light component.

JP 2000-75207 A describes a fluorescence microscope having a scattered light reducing means. Behind a beam splitter that serves simultaneously as an excitation filter, the undesired light passing through is directed onto a light trap arranged outside the beam splitter cube. This trap comprises a hollow conical body in which the incoming undesired light is swallowed up by multiple reflections. This light trap requires considerable installation space in addition to the actual beam splitter cube. This configuration of the beam splitter cube is moreover also open, so that dust can get into the beam splitter cube and can generate an additional scattered light component.

### SUMMARY OF THE INVENTION

It is therefore an object of the present invention to provide a microscope having a scattered light reducing device that has a particularly compact configuration and at the same time a good scattered light reducing effect.

The present invention provides a microscope, having at least one beam splitter in the microscope beam path and a scattered light reducing device, which according to the present invention is characterized in that the scattered light reducing device is embodied as a black glass plate that has a polished surface on which an antireflection coating is applied. Advantageous embodiments are described in the dependent claims.

In the microscope according to the present invention, the light passing through the beam splitter is not scattered at the back wall of the beam splitter cube, as is known from the existing art. Instead, the light passing through the beam splitter experiences extreme absorption in the black glass plate, the antireflection coating causing only a very small residual reflection which is returned through the beam splitter back into the illumination beam path. The polished surface of the black glass plate ensures that only reflection, and no scattering, occurs.

In an advantageous embodiment, the black glass plate is arranged behind the beam splitter with its surface normal line at a slight inclination with respect to the direction of the incoming light. Because of the oblique position of the black glass plate, the small residual reflection occurring at the black glass plate is reflected obliquely, at a small angle, toward the beam splitter. The residual reflection arrives back at the beam splitter and, in accordance with its beam splitter properties, is partially reflected by it out of the microscope beam path. The portion of the residual reflection not reflected at the beam splitter travels through the beam splitter back into the illumination beam path.

The angle at which the surface normal line of the black glass plate is inclined with respect to the direction of the incoming light depends, for example, on the focal lengths of the tube optical system and on the size of the image field. Depending on these data, angular values of approximately 2 degrees have proven to be the minimum necessary to ensure that the residual reflection does not travel into the camera and the eyepieces.

With beam splitters in so-called fluorescence cubes having an excitation filter and a barrier filter, the oblique position of the black glass plate with respect to the direction of the incoming light is particularly advantageous when the excitation filter is a filter for multi-band fluorescence excitation using several spectral fluorescence bands. In this case the associated multi-band barrier filter likewise has a multi-band characteristic in order to extinguish the various excitation bands of the excitation filter. That extinction is, however, not as good with a multi-band barrier filter as it is with a single-band barrier filter that is matched to a single-band excitation filter. With single-band barrier filters the extinction is almost 100%, whereas with a multi-band barrier filter it is considerably poorer, so that components of the exciting light can still arrive at the eyepiece and the camera port. An oblique position of the black glass plate with respect to the direction of the incoming light is therefore particularly advantageous in the case of multi-band fluorescence excitation, since the residual reflection produced at the black glass plate is thereby reliably reflected out of the imaging beam path so that troublesome light cannot arrive at the eyepiece and the camera port.

In a particularly compact configuration, the black glass plate is integrated together with the beam splitter into a beam splitter cube. The beam splitter cube can additionally be embodied in closed, dust-tight fashion. The beam splitter cube can be configured for various microscopy methods. For example, the beam splitter cube can be embodied as a bright-field cube in which only a beam splitter is arranged. In another configuration, the beam splitter cube is embodied as a fluorescence cube in which an excitation filter and a barrier filter are arranged in addition to the beam splitter. In a further configuration, the beam splitter cube is embodied as a polarization cube in which a polarizer and an analyzer are arranged in addition to the beam splitter.

In an advantageous embodiment of the microscope, several beam splitter cubes are arranged on a rotatable turret or a sliding element so that they are reversibly insertable into the microscope beam path in selectably alternating fashion. Different beam splitter cubes of the types described above can be involved here.

### BRIEF DESCRIPTION OF THE DRAWINGS

The invention will be described in more detail below with reference to the schematic drawings, in which:

FIG. 1 shows a beam splitter cube for a bright-field application of the microscope;

FIG. 2 shows a fluorescence microscope having a fluorescence cube.

### DETAILED DESCRIPTION

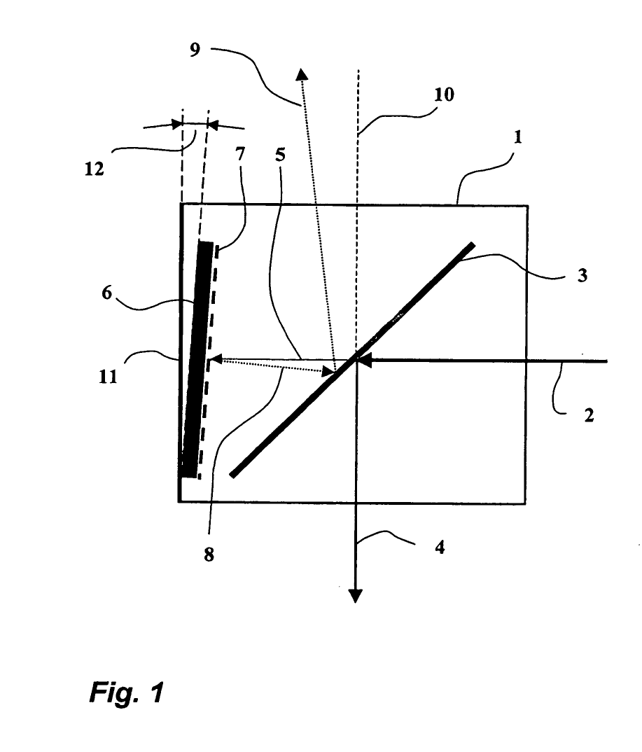

FIG. 1 shows a beam splitter cube 1 for a bright-field application of a microscope. An illuminating beam 2 of an illumination beam path enters beam splitter cube 1 from the right. Illumination beam 2 strikes a beam splitter 3 at which a reflected beam 4 is deflected to the observed specimen. A passthrough beam 5 is allowed to pass through beam splitter 3. It strikes an obliquely placed black glass plate 6 having a polished surface on which an antireflection coating 7 is applied in homogeneous and planar fashion. The effect of the polished surface is that only reflection (and no scattering) occurs. As a result of antireflection coating 7 of the surface of black glass plate 6, only a very small portion, i.e. less than 1%, of beam 5 striking the obliquely placed black glass plate 6 is reflected.

Black glass plate 6 is inclined at a small inclination angle 12 with respect to back wall 11 of beam splitter cube 1. This is synonymous with the inclination of the surface normal line of black glass plate 6 with respect to the passthrough beam 5.

Because black glass plate 6 is set obliquely by a few degrees, the very small residual reflection 8 is reflected at a small angle and travels back to strike beam splitter 3 obliquely. Residual reflection 8 arrives back at beam splitter 3 and, in accordance with the latter's beam splitter properties, is partially reflected by it out of the microscope beam path. The portion of residual reflection 8 not reflected at beam splitter 3 passes back through beam splitter 3 into the illumination beam path, oppositely to illuminating beam 2.

Residual reflection 8 is reflected by beam splitter 3 at an angle such that this residual reflection 9 reflected by the beam splitter no longer follows optical axis 10 of the microscope and thus no longer enters the eyepiece or the camera port. The background light or scattered light in the microscope can be greatly reduced by way of the above-described arrangement and configuration of black glass plate 6.

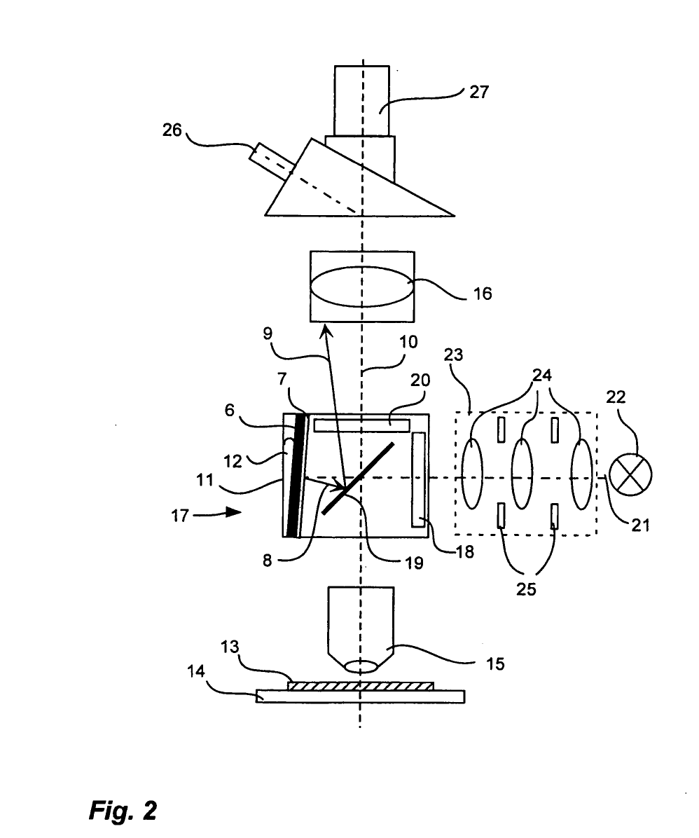

FIG. 2 shows a microscope having a fluorescence device. A sample 13 is placed on a microscope stage 14. A fluorescence device comprises an excitation filter 18, a dichroic beam splitter 19, and a barrier filter 20. This fluorescence device is embodied, as a physical unit, as a fluorescence cube 17.

To allow sample 13 to be examined using the fluorescence device, an incident-light beam 21 is conveyed to the fluorescence device. This beam proceeds from an incident-light source 22 and passes through an incident-light illumination optical system 23 having several lens elements 24 and apertures 25. The light of incident-light beam 21 enters fluorescence cube 17 laterally and travels through excitation filter 18, which permits only specific spectral fluorescence wavelength regions of the illuminating light to pass.

The incident light is then deflected by means of beam splitter 19 toward objective 15, and directed through objective 15 onto sample 13. The incident light produces a fluorescence excitation in specific fluorochromes introduced into sample 13. From sample 13, the fluorescent light travels through objective 15, beam splitter 19, and barrier filter 20 into tube optical system 16. The image of sample 13 generated by the latter can be viewed by means of one or more eyepieces 26. The image is also imaged onto a camera 27.

Arranged behind beam splitter 19 is a black glass plate 6 having a surface normal line at a small inclination angle 12 with respect to the direction of the light arriving through beam splitter 19. Black glass plate 6 has a polished surface onto which an antireflection coating 7 is applied. The polished surface ensures that exclusively reflection (and no scattering) occurs. Light 5 passing through beam splitter 19 experiences extreme absorption in black glass plate 6, and only a very small residual reflection 8 is reflected at a very small angle.

Because of the slightly oblique position of black glass plate 6, the extremely small residual reflection 8 travels obliquely back to beam splitter 19. It is then reflected at an angle by beam splitter 19, so that this residual light 9 is deflected away from optical axis 10 of the microscope and no longer enters eyepiece 26 or camera 27.

In single-band fluorescence arrangements, black glass plate 6 can theoretically even be arranged without an inclination, since the barrier filter does not allow passage of the spectral excitation bands of the excitation filter. Conversely, in the case of all multi-band fluorescence excitations and bright-field cubes, in cubes for differential interference contrast (DIC) and for polarization cubes, an additional oblique setting of black glass plate 6 is definitely advantageous and results in better diminution of the residual reflection.

### PARTS LIST

1 Beam splitter cube

2 Illuminating beam

3 Beam splitter

4 Reflected beam

5 Beam

6 Black glass plate

7 Antireflection coating

8 Residual reflection

9 Residual reflection reflected from beam splitter

10 Optical axis

11 Back wall of beam splitter cube

12 Inclination angle

13 Sample

14 Microscope stage

15 Objective

16 Tube optical system

17 Fluorescence cube

18 Excitation filter

19 Dichroic beam splitter

20 Barrier filter

21 Incident-light beam

22 Incident-light source

23 Incident-light illumination optical system

24 Lens elements

25 Apertures

26 Eyepieces

27 Camera

What is claimed is:

1. A microscope comprising:
a microscope beam path;
at least one beam splitter in said microscope beam path;
a scattered light reducing device;
said scattered light reducing device being embodied as a black glass plate that has a polished surface on which an antireflection coating is applied.

2. The microscope as defined in claim 1, wherein said black glass plate is arranged behind said beam splitter at a slight inclination with respect to the direction of an incoming illumination beam, so that a residual reflection occurring at said black glass plate is reflected out of said microscope beam path by said beam splitter.

3. The microscope as defined in claim 1, wherein said black glass plate is integrated together with said beam splitter into a beam splitter cube.

4. The microscope as defined in claim 2, wherein said black glass plate is integrated together with said beam splitter into a beam splitter cube.

5. The microscope as defined in claim 3, wherein said black glass plate is integrated together with said beam splitter into a beam splitter cube, and said beam splitter cube embodied in closed, dust-tight fashion.

6. The microscope as defined in claim 4, wherein said black glass plate is integrated together with said beam splitter into a beam splitter cube, and said beam splitter cube is embodied in closed, dust-tight fashion.

7. The microscope as defined in claim 3, wherein said beam splitter cube is embodied as a bright-field cube in which only a beam splitter is arranged.

8. The microscope as defined in claim 4, wherein said beam splitter cube is embodied as a bright-field cube in which only a beam splitter is arranged.

9. The microscope as defined in claim 3, wherein said beam splitter cube is embodied as a fluorescence cube in which an excitation filter and a barrier filter are arranged in addition to said beam splitter.

10. The microscope as defined in claim 4, wherein said beam splitter cube is embodied as a fluorescence cube in which an excitation filter and a barrier filter are arranged in addition to said beam splitter.

11. The microscope as defined in claim 3, wherein said beam splitter cube is embodied as a polarization cube in which a polarizer and an analyzer are arranged in addition to said beam splitter.

12. The microscope as defined in claim 4, wherein said beam splitter cube is embodied as a polarization cube in which a polarizer and an analyzer are arranged in addition to said beam splitter.

13. The microscope as defined in claim 3, wherein several beam splitter cubes are arranged on a rotatable turret or a sliding element so that they are reversibly insertable into said microscope beam path in selectably alternating fashion.

14. The microscope as defined in claim 4, wherein several beam splitter cubes are arranged on a rotatable turret or a sliding element so that they are reversibly insertable into said microscope beam path in selectably alternating fashion.

15. Optical beam splitter cube useable in a microscope beam path comprising:
at least one beam splitter;
a scattered light reducing device;
said scattered light reducing device being embodied as a black glass plate that has a polished surface on which an antireflection coating is applied.

16. Optical beam splitter cube as defined in claim 15, wherein said black glass plate is arranged behind said beam splitter at a slight inclination with respect to the direction of an incoming illumination beam, so that a residual reflection occurring at said black glass plate is reflected out of the microscope beam path by said beam splitter.

17. Optical beam splitter cube as defined in claim 16, being embodied in closed, dust-tight fashion.

18. Optical beam splitter cube as defined in claim 16, being embodied as a bright-field cube in which only a beam splitter is arranged.

19. Optical beam splitter cube as defined in claim 16, being embodied as a fluorescence cube in which an excitation filter and a barrier filter are arranged in addition to said beam splitter.

20. Optical beam splitter cube as defined in claim 16, being embodied as a polarization cube in which a polarizer and an analyzer are arranged in addition to said beam splitter.
